(19) United States
(12) Patent Application Publication
(10) Pub. No.: US 2024/0105904 A1
(43) Pub. Date: Mar. 28, 2024

(54) METHOD FOR MANUFACTURING NEGATIVE ELECTRODE PLATE, NEGATIVE ELECTRODE PLATE, AND RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventors: Yoshinori KUDO, Toyohashi-shi (JP); Masumi TANIMOTO, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/370,130

(22) Filed: Sep. 19, 2023

(30) Foreign Application Priority Data
Sep. 22, 2022 (JP) 2022151624

(51) Int. Cl. H01M 4/04; H01M 4/13; H01M 4/139

(52) U.S. Cl. CPC H01M 4/0404; H01M 4/13; H01M 4/139; H01M 2004/027

(57) ABSTRACT

A method for manufacturing a negative electrode plate of a rechargeable battery is provided. The method includes kneading a negative electrode active material and a negative electrode additive to form a negative electrode mixture paste; applying the negative electrode mixture paste to a negative electrode current collector; and drying the negative electrode mixture paste. The blackness of a material prepared by kneading the negative electrode active material and the negative electrode additive is set in a range of 4 to 16. The viscosity of a negative electrode thickener contained in the negative electrode additive is set in a range of 13000 mPa·s to 21000 mPa·s when a shear rate is 0.01 s⁻¹.

### BACKGROUND

### 1. Field

The following description relates to a method for manufacturing a negative electrode plate, a negative electrode plate, and a rechargeable battery.

### 2. Description of Related Art

Japanese Laid-Open Patent Publication No 2010-272287 discloses a method for inspecting a lithium rechargeable battery to determine whether a negative electrode paste meets the required standards based on the blackness of a primary kneaded material obtained when the negative electrode paste is prepared. If the blackness of the primary kneaded material has a value within a predetermined reference blackness range, the primary kneaded material will pass the test, and the primary kneaded material will be used to prepare the negative electrode paste.

The battery performance, such as the resistance characteristic and the duration characteristic, is not affected only by the blackness but also by other factors. In this respect, Japanese Laid-Open Patent Publication No 2010-272287 uses only the blackness to determine the battery performance and does not use other factors to determine the battery performance. Thus, further research is needed to optimize the battery materials.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a negative electrode plate of a rechargeable battery is provided. The method includes kneading a negative electrode active material and a negative electrode additive to form a negative electrode mixture paste; applying the negative electrode mixture paste to a negative electrode current collector; and drying the negative electrode mixture paste. The blackness of a material prepared by kneading the negative electrode active material and the negative electrode additive is set in a range of 4 to 16. The viscosity of a negative electrode thickener contained in the negative electrode additive is set in a range of 13000 mPa s to 21000 mPa s when a shear rate is 0.01 s⁻¹.

In another general aspect, a negative electrode plate includes a negative electrode current collector forming a substrate of a negative electrode of a rechargeable battery, and a negative electrode mixture layer formed by applying a negative electrode mixture paste to the negative electrode current collector and drying the negative electrode mixture paste, the negative electrode mixture paste being prepared by kneading a negative electrode active material and a negative electrode additive. A kneaded material of the negative electrode active material and the negative electrode additive has a blackness in a range of 4 to 16. The negative electrode additive contains a negative electrode thickener having a viscosity in a range of 13000 mPa·s to 21000 mPa·s when a shear rate is 0.01 s⁻¹.

In another general aspect, a rechargeable battery includes a negative electrode plate of a negative electrode, a positive electrode plate of a positive electrode, and a separator arranged between the negative electrode plate and the positive electrode plate. The negative electrode plate includes a negative electrode current collector that forms a substrate of the negative electrode and a negative electrode mixture layer formed by applying a negative electrode mixture paste to the negative electrode current collector and drying the negative electrode mixture paste, the negative electrode mixture paste being prepared by kneading a negative electrode active material and a negative electrode additive. A kneaded material of the negative electrode active material and the negative electrode additive has a blackness in a range of 4 to 16. The negative electrode additive contains a negative electrode thickener having a viscosity in a range of 13000 mPa s to 21000 mPa s when a shear rate is 0.01 s⁻¹.

Other features and aspects will be apparent from the following detailed description, the drawings, and the claims.

### BRIEF DESCRIPTION OF THE DRAWINGS

FIG. 1 is a perspective view of a rechargeable battery according to one embodiment.

FIG. 2 is a diagram showing an electrode body.

FIG. 3 is a diagram showing a procedure for preparing a negative electrode mixture paste.

FIG. 4 is a table of parameter values of a comparative example and examples.

FIG. 5 is a graph showing the relationship between the shear viscosity of a negative electrode mixture paste and the shear rate.

FIG. 6 is a partially enlarged view of FIG. 5.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A method for method for manufacturing a negative electrode plate, a negative electrode plate, and a rechargeable battery according to one embodiment will now be described.

Rechargeable Battery 1

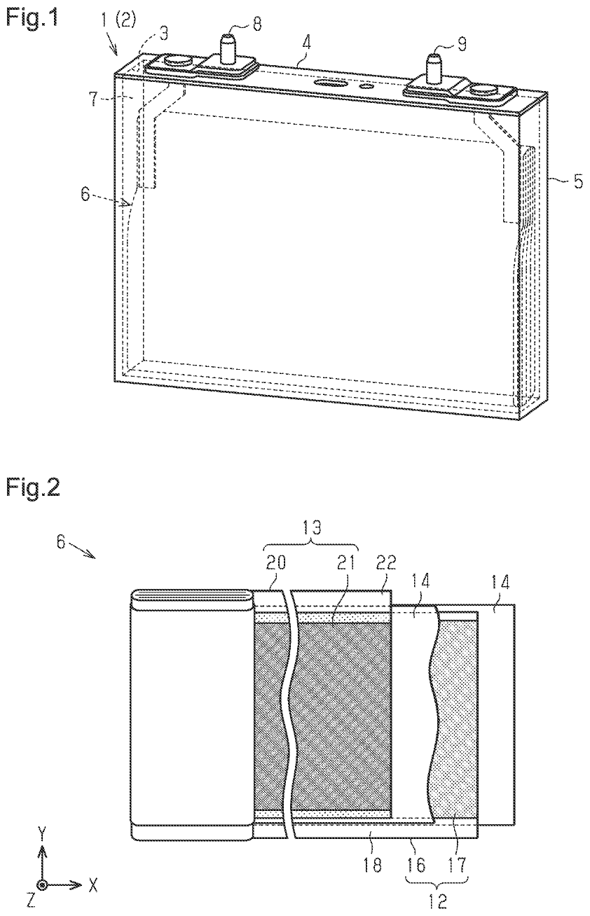

As shown in FIG. 1, a cell 2 of a rechargeable battery 1 includes a box-shaped battery case 5 having an opening 3 that is closed by a lid 4. The battery case 5 is formed from, for example, metal such as an aluminum alloy. The inside of the battery case 5 defines a sealed battery container. The battery case 5 accommodates an electrode body 6 that is a stack of positive and negative electrodes. The battery case 5 is filled with a non-aqueous electrolyte 7. The lid 4 of the cell 2 includes a positive electrode external terminal 8 and a negative electrode external terminal 9 that are electrically connected to the electrode body 6. The rechargeable battery 1 is, for example, a lithium-ion battery in which lithium ions move between the positive and negative electrodes.

Electrode Body 6

As shown in FIG. 2, the electrode body 6 includes a negative electrode plate 12, a positive electrode plate 13, and separators 14. The negative electrode plate 12, the positive electrode plate 13, and the separators 14 are stacked in the thickness direction of the electrode body 6 (Z-axis direction of FIG. 2). Specifically, the negative electrode plates 12 and the positive electrode plates 13 are arranged one over the other, and the separators 14 are arranged between the negative electrode plate 12 and the positive electrode plate 13. For example, the electrode body 6 may be a rolled electrode body as shown in FIG. 2. The rolled electrode body 6 is formed by rolling a long stack of the negative electrode plate 12, the positive electrode plate 13, and the separators 14 about a rolling axis in the longitudinal direction (X-axis direction of FIG. 2). In one example, the rolled electrode body 6 has a flattened form as viewed in the direction (Y-axis direction in FIG. 2) that is orthogonal to the longitudinal direction.

Negative Electrode Plate 12

The negative electrode plate 12 includes a negative electrode current collector 16 and negative electrode mixture layers 17. The negative electrode current collector 16 is the substrate of the negative electrode. The negative electrode current collector 16 is formed from, for example, copper (copper foil). The negative electrode mixture layers 17 are applied to the two surfaces of the negative electrode current collector 16. Each negative electrode mixture layer 17 includes, for example, a negative electrode active material and a negative electrode additive. The negative electrode mixture layer 17 on the negative electrode current collector 16 is formed by applying a negative electrode mixture paste to the negative electrode current collector 16 and drying the negative electrode mixture paste, the negative electrode mixture paste being prepared by kneading the negative electrode active material and the negative electrode additive.

The negative electrode active material includes, for example, a material capable of storing and releasing lithium ions. The negative electrode active material may be, for example, a powdery carbon material such as graphite or the like. The negative electrode additive includes, for example, a negative electrode solvent, a negative electrode binder, and a negative electrode thickener. The negative electrode solvent may be, for example, water or the like. The negative electrode additive may further include, for example, a negative electrode conductive material or the like.

The negative electrode binder may be, for example, a polymeric material dispersed in water. The polymeric material may be, for example, vinyl acetate copolymer, styrene-butadiene block copolymer (SBR), acrylic acid-modified SBR resin (SBR latex), or rubber such as gum arabic. The polymeric material may be, for example, fluorine resin such as polyethylene oxide (PEO), polytetrafluoroethylene (PTFE), tetrafluoroethylene-perfluoroalkyl vinyl ether copolymer (PFA), tetrafluoroethylene-hexafluoropropylene copolymer (FEP), ethylene-tetrafluoroethylene copolymer (ETEC), and the like. One type of the polymeric materials may be used alone or two or more types of the polymeric materials may be used in combination.

The negative electrode thickener may be, for example, polymers that are insoluble in an organic solvent and exhibit viscosity when dissolved in water. The polymers may be, for example, a cellulose derivative such as carboxymethyl cellulose (CMC), methyl cellulose (MC), or the like.

The negative electrode current collector 16 includes a negative electrode connection portion 18 connected to the negative electrode external terminal 9 by a negative electrode current collector plate 9a. The negative electrode connection portion 18 is, for example, a region where the two surfaces of the negative electrode current collector 16 are free from the negative electrode mixture layer 17. The negative electrode connection portion 18 is exposed from the positive electrode plate 13 and the separators 14.

Positive Electrode Plate 13

The positive electrode plate 13 includes a positive electrode current collector 20 and positive electrode mixture layers 21. The positive electrode current collector 20 is the substrate of the positive electrode. The positive electrode current collector 20 is formed from, for example, aluminum (aluminum foil, aluminum alloy foil). Each positive electrode mixture layer 21 includes, for example, a positive electrode active material and a positive electrode additive. The positive electrode mixture layer 21 on the positive electrode current collector 20 is formed by applying a positive electrode mixture paste to the positive electrode current collector 20 and drying the positive electrode mixture paste, the positive electrode mixture paste being prepared by kneading the positive electrode active material and the positive electrode additive.

The positive electrode active material includes, for example, a material capable of storing and releasing lithium ions. The positive electrode active material may be, for example, a ternary (NMC) lithium-containing composite oxide containing nickel, manganese, and cobalt, such as a lithium nickel cobalt manganese oxide (LiNiCoMnO₂). Instead, the positive electrode active material may be, for example, any one of lithium cobaltate (LiCoO₂), lithium manganate (LiMn₂O₄), and lithium nickelate (LiNiO₂) may be used. Instead, the positive electrode active material may be, for example, a lithium-containing composite oxide containing nickel, cobalt, and aluminum (NCA).

The positive electrode additive includes, for example, a positive electrode solvent, a positive electrode conductive material, and a positive electrode binder. The positive electrode solvent may be, for example, a non-aqueous solvent such as an NMP (N-methyl-2-pyrrolidone) solution. The positive electrode conductive material may be, for example, carbon fibers such as carbon nanotubes (CNT), carbon nanofibers (CNF), or the like. Alternatively, the positive electrode conductive material may be, for example, carbon black such as graphite, acetylene black (AB), Ketjen black, or the like. The positive electrode binder may be, for example, the same as the negative electrode binder. The positive electrode additive may further include, for example, a positive electrode thickener or the like.

The positive electrode current collector 20 includes a positive electrode connection portion 22 connected to the positive electrode external terminal 8 by a positive electrode current collector plate 8a. The positive electrode connection portion 22 is, for example, a region where the two surfaces of the positive electrode current collector 20 are free from the positive electrode mixture layer 21. The positive electrode connection portion 22 is exposed from the negative electrode plate 12 and the separators 14.

Separator 14

Each separator 14 is, for example, a nonwoven fabric formed from a porous resin such as polypropylene. The separator 14 may be one of or a combination of a porous polymer film such as a porous polyethylene film, a porous polyolefin film, a porous polyvinyl chloride film, or the like, or a lithium-ion or ion-conductive polymer electrolyte film. When the electrode body 6 is immersed in the non-aqueous electrolyte 7, the non-aqueous electrolyte 7 permeates the separator 14.

Non-Aqueous Electrolyte 7

The non-aqueous electrolyte 7 is a composition in which supporting salt is contained in a non-aqueous solvent. The non-aqueous solvent may be, for example, ethylene carbonate (EC). The non-aqueous solvent may be one, two, or more types of materials selected from the group including propylene carbonate (PC), diethyl carbonate (DEC), dimethyl carbonate (DMC), ethyl methyl carbonate (EMC), and the like.

Examples of the supporting salt include LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like. The supporting salt may be one, two, or more types of lithium compounds (lithium salts) selected from the above examples. In this manner, the non-aqueous electrolyte 7 contains a lithium compound.

Procedure for Preparing Negative Electrode Mixture Paste

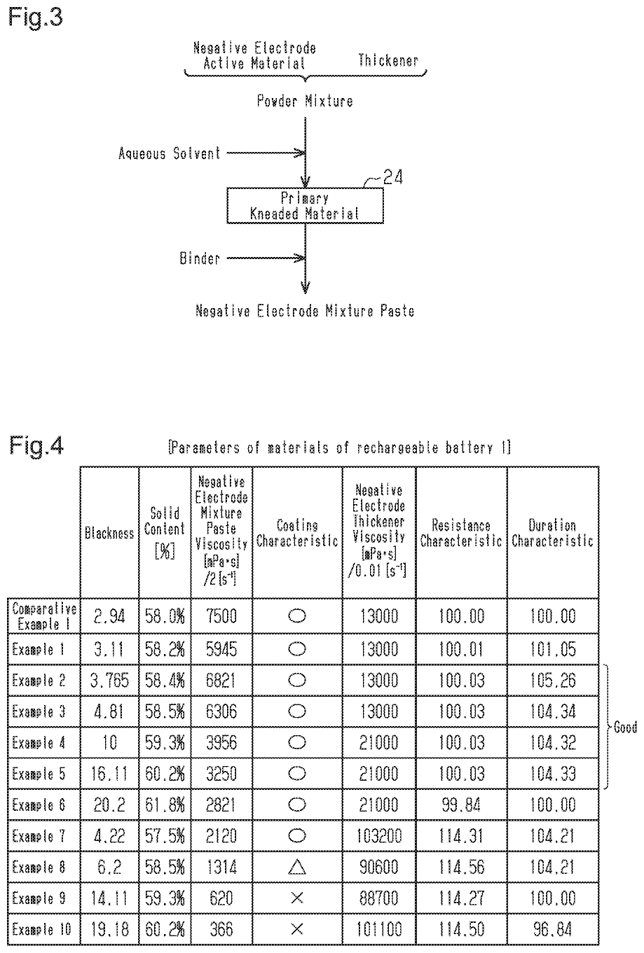

As shown in FIG. 3, when the negative electrode mixture paste is prepared, first, the negative electrode active material and the negative electrode thickener are mixed at a predetermined mixing ratio to prepare a powder mixture. Then, an aqueous solvent is added to the powder mixture, which is then kneaded to prepare a primary kneaded material 24. When preparing the primary kneaded material 24, the aqueous solvent may be added to the powder mixture a number of times to uniformly and sufficiently disperse the negative electrode active material and the negative electrode thickener in the aqueous solvent.

Subsequently, the negative electrode binder is added to the primary kneaded material 24 that is further kneaded to prepare the negative electrode mixture paste. The negative electrode mixture paste is applied to the surfaces of the negative electrode current collector 16. Any type of known kneading device (for example, agitation device or the like) can be used. Examples of the kneading device include an agitator having rotating blades, a fill mixer, a medium stirring mill, a planetary mixer, and the like.

Blackness of Negative Electrode Mixture Paste

Since the negative electrode mixture paste is prepared by kneading various types of materials at a predetermined mixing ratio, the negative electrode mixture paste will have different characteristics depending on how it is prepared. A change in the characteristics of the negative electrode mixture paste will change the quality of the negative electrode (negative electrode plate 12) and greatly affect the battery performance of the rechargeable battery 1. Thus, the characteristics of the negative electrode mixture paste should be optimized to improve the performance of the rechargeable battery 1.

The quality of the negative electrode mixture paste is known to have correlation with, for example, the blackness of the primary kneaded material 24. The blackness is a parameter indicating the conditions of the negative electrode active material such as cracking, peeling, and chipping. The blackness is varied in accordance with, for example, the amount of the negative electrode thickener and the conditions of the primary kneaded material 24. The conditions of the primary kneaded material 24 correspond to, for example, a parameter indicating whether the negative electrode active material and the negative electrode thickener are uniformly and sufficiently dispersed in the primary kneaded material 24. The conditions of the primary kneaded material 24 can vary in accordance with, for example, the shearing force applied to the material (for example, shearing strength), the mixing ratio of materials, how kneading is carried out, or the like when the primary kneaded material 24 is prepared. For example, the blackness can be measured on the basis of a method for measuring blackness disclosed in Japanese Laid-Open Patent Publication No. 2010-272287.

When the shearing force (for example, shearing strength) during kneading is increased, the viscosity of the primary kneaded material 24 (negative electrode mixture paste) relatively decreases. This is because the negative electrode thickener becomes finer during the kneading, thus allowing the negative electrode active material and the negative electrode thickener to be uniformly and sufficiently mixed. In contrast, when the shearing force (for example, shearing strength) during kneading is insufficient, the viscosity of the primary kneaded material 24 (negative electrode mixture paste) will relatively increase. In this manner, the viscosity of the primary kneaded material 24 (negative electrode mixture paste) will correspond to the shearing force (for example, shearing strength) during kneading.

Parameter Setting for Materials of Negative Electrode Mixture Layer 17

FIG. 4 shows a table of parameter values of a comparative example and examples. The table of FIG. 4 shows columns of parameters including, for example, blackness, solid content (%), negative electrode mixture paste viscosity (mPa·s) (shear rate: 2 s⁻¹), a coating characteristic, negative electrode thickener viscosity (mPa·s) (shear rate: 0.01 s⁻¹), a resistance characteristic, and a duration characteristic. Samples of ten patterns from Examples 1 to 10 were measured using Comparative Example 1 as a reference for comparison. The parameters are defined as follows.

Blackness: Blackness of the primary kneaded material 24

Solid content (%): Percentage of the powder mixture (negative electrode active material and negative electrode thickener) in the primary kneaded material 24 (negative electrode active material, negative electrode thickener, aqueous solvent)

Negative electrode mixture paste viscosity (mPa·s): Viscosity of the negative electrode mixture paste

Coating characteristic: Can negative electrode mixture paste be discharged from a coating device (∘ means good, Δ means poor, x means bad)

Negative electrode thickener viscosity (mPa·s): Viscosity of the negative electrode thickener

Resistance characteristic: Change in resistance of battery compared with Comparative Example 1 as reference

Duration characteristic: Change in the battery life as compared with Comparative Example 1 as reference

The negative electrode thickener viscosity is a value measured by a rheometer that can change the rotation speed in any manner. The rheometer measures viscosity from, for example, a phase difference between stress and strain when a sine wave stress is applied to a measured subject. A larger value of the duration characteristic is desirable. A smaller value of the resistance characteristic is desirable.

A higher blackness of the primary kneaded material 24 will improve the duration characteristic of the rechargeable battery 1. However, when the blackness becomes too high, the duration characteristic will not improve. Thus, the blackness has an optimum range. In the present example, the blackness of the material (primary kneaded material 24) prepared by kneading the negative electrode active material and the negative electrode additive is set to a value in a range of 4 to 16.

As shown in FIG. 4, the resistance characteristic of the rechargeable battery 1 is correlated with the viscosity of the negative electrode thickener. Specifically, when the viscosity of the negative electrode thickener is too high, the resistance characteristic deteriorates. Thus, in the present example, the viscosity of the negative electrode thickener used in the negative electrode mixture layer 17 is set to a value in a range of 13000 mPa s to 21000 mPa s when the shear rate is 0.01 s⁻¹.

Further, in the present example, the solid content of the primary kneaded material 24 is set in a range of 58% to 61%. The primary kneaded material 24 softens as the value of the solid content decreases and hardens as the value of the solid content increases. Shearing force applied to the negative electrode mixture paste can be adjusted by changing the solid content.

Operation of Embodiment

The operation of the method for manufacturing a negative electrode plate (rechargeable battery 1 and negative electrode plate 12) of the present embodiment will now be described.

As shown in FIG. 4, the blackness of the primary kneaded material 24 was adjusted based on, for example, the solid content of the primary kneaded material 24 set at the target value. For example, for samples of the negative electrode thickener having the same viscosity, the blackness of the primary kneaded material 24 was changed by changing the value of the solid content. In one example, in the four samples of Comparative Example 1 and Examples 1 to 3 (negative electrode thickeners have the same viscosity of 13000 mPa s), the blackness increased as the solid content increased.

When the blackness of the primary kneaded material 24 was too low (refer to, for example, Example 1), the duration characteristic of the battery was not significantly improved. When the blackness was relatively low, the shearing force during kneading was insufficient. Thus, the negative electrode thickener did not sufficiently coat the surface of the negative electrode active material. This decomposes the non-aqueous electrolyte 7 at the active point of the negative electrode and shortens the battery life. Thus, the blackness should not be too low.

In contrast, when the blackness of the primary kneaded material 24 was too high (refer to, for example, Example 6 and Example 10), the duration characteristic of the battery did not change or deteriorate. When the blackness was relatively high, the shearing force during kneading increased and coating of the negative electrode thickener was sufficient. However, the non-aqueous electrolyte 7 was easily decomposed at the active point of the negative electrode when the fine powder of the negative electrode active material increased. Such an increase in local reaction may shorten the battery life. Thus, the blackness should not be too high.

When the blackness is adjusted, the resistance characteristic of the battery has a value that is in accordance with the viscosity of the negative electrode thickener. Specifically, as shown in Examples 1 to 5, when the blackness was adjusted and the viscosity of the negative electrode thickener was in a range of 13000 mPa s to 21000 mPa s, the resistance characteristic did not deteriorate. In contrast, as shown in Examples 7 to 10, when the blackness was adjusted and the viscosity of the negative electrode thickener was higher than 21000 Pa s, the resistance characteristic deteriorated. Thus, the viscosity of the negative electrode thickener is greatly related to the resistance characteristic of the battery.

When the viscosity of the negative electrode thickener is relatively high, the molecular weight of the negative electrode thickener increases, and a portion of the negative electrode active material that is not coated with the negative electrode thickener increases. This will lead to an increase in the resistance of the battery, that is, deterioration of the resistance characteristic. Thus, the viscosity of the negative electrode thickener should not be relatively high to ensure the resistance characteristic.

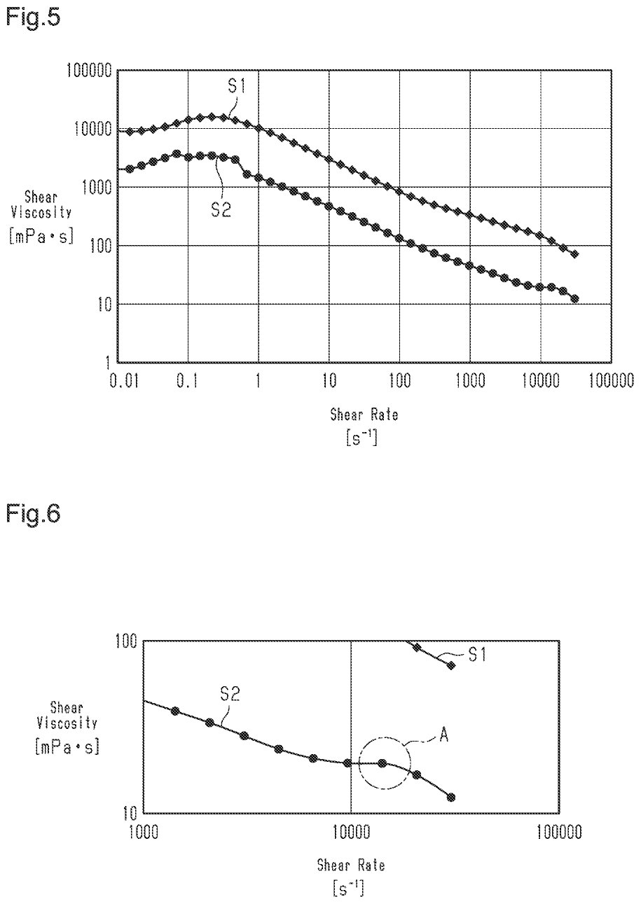

FIG. 5 is a logarithmic graph showing the relationship between the shear rate and the shear viscosity of the negative electrode mixture paste. FIG. 5 shows a shear viscosity waveform S1 of Example 2 in which the viscosity of a negative electrode thickener is 13000 mPa s and a shear viscosity waveform S2 of Example 8 in which the viscosity of a negative electrode thickener is 96000 mPa s. When the shear rate is increased, in the waveform of Examples 2 and 8, the shear viscosity reaches a predetermined peak value and then gradually decreases.

As shown in FIG. 6, when the shear rate exceeds 10000 s⁻¹ in Example 8, the shear viscosity decreases and then instantaneously increases, that is, dilatancy occurs (long-dash short-dash line A of FIG. 6). When dilatancy occurs, the negative electrode mixture paste will be difficult to be discharged from the coating device. Thus, Example 8 is not a material suitable for preparation. In this respect, the use of a negative electrode thickener having a relatively high viscosity is not desirable.

As shown in FIG. 4, when comparing the parameters of the samples of Examples 1 to 10, the preferable viscosity of the negative electrode thickener is in a range of 13000 mPa s to 21000 mPa s. However, as can be seen from Examples 1 and 6, even when the viscosity of the negative electrode thickener is set to a value in the range of 13000 mPa s to 21000 mPa s, if the blackness is too low or too high, at least one of the resistance characteristic and the duration characteristic do not have the optimum value.

In the present example, the optimum combination of the blackness and the negative electrode thickener viscosity is set based on the above observation. Specifically, the blackness of the material (primary kneaded material 24 in present example) prepared by kneading the negative electrode active material and the negative electrode additive is set in a range of 4 to 16, and the negative electrode thickener viscosity is set in the range of 13000 mPa s to 21000 mPa s. This allows the rechargeable battery 1 to be manufactured with an improvement in the resistance characteristic and the duration characteristic. Further, a low negative electrode thickener viscosity restricts the occurrence of dilatancy during coating.

Advantages of Embodiment

The method for manufacturing a negative electrode plate (rechargeable battery 1 and negative electrode plate 12) in the above embodiment has the following advantages.
(1) The method for manufacturing a negative electrode plate of the present example manufactures the negative electrode plate 12 of the rechargeable battery 1 by applying the negative electrode mixture paste to the negative electrode current collector 16 and drying the negative electrode mixture paste, the negative electrode mixture paste being prepared by kneading the negative electrode active material and the negative electrode additive. The blackness of the material prepared by kneading the negative electrode active material and the negative electrode additive is set in the range of 4 to 16, and the viscosity of the negative electrode thickener contained in the negative electrode additive is set in the range of 13000 mPa·s to 21000 mPa·s when the shear rate is 0.01 s⁻¹.

With this configuration, the optimum range of the blackness of the material, prepared by kneading the negative electrode active material and the negative electrode additive, minimizes a situation in which the negative electrode thickener does not sufficiently coat the negative electrode active material or a situation in which fine powder of the negative electrode thickener increases. Thus, the non-aqueous electrolyte 7 does not decompose at the active point of the negative electrode, and the battery life is prolonged. Further, the optimum range of the viscosity of the negative electrode thickener restricts increases in the amount of the negative electrode active material coated with the negative electrode thickener. Thus, battery resistance will be relatively low. This will improve the battery performance of the rechargeable battery 1.
(2) The negative electrode additive includes at least the negative electrode thickener and the negative electrode solvent. The blackness of the material, prepared by kneading the negative electrode active material and the negative electrode additive, is the blackness of the primary kneaded material 24 prepared by kneading the negative electrode active material, the negative electrode thickener, and the negative electrode solvent. With this configuration, the blackness of the primary kneaded material 24 is optimized to improve the battery performance of the rechargeable battery 1.
(3) In the method for manufacturing a negative electrode plate of the present example, the solid content of the primary kneaded material 24 is in the range of 58% to 61%. With this configuration, the range of the solid content of the primary kneaded material 24 is also optimized, and the battery performance of the rechargeable battery 1 is further improved.

### Other Embodiments

The present embodiment may be modified as follows. The present embodiment and the following modifications can be combined if the combined modifications remain technically consistent with each other.

The blackness does not need to be the blackness of the primary kneaded material 24 and may be, for example, the blackness of the material (negative electrode mixture paste) prepared by kneading the primary kneaded material 24 and the negative electrode binder.

The viscosity range of the negative electrode thickener does not need to be for the shear rate of 0. 01 s⁻¹ and may be for a different shear rate.

The negative electrode binder may be, for example, styrene-butadiene rubber (SBR), polyvinylidene fluoride (PVDF), polyvinyl alcohol (PVA) or the like.

Any type of active material, conductive material, solvent, and binder may be used in the negative electrode and the positive electrode.

The rechargeable battery 1 does not need to be a lithium-ion battery and may be of any type.

The rechargeable battery 1 does not need to have a flattened form and may have any shape such as that of a cylinder.

The rechargeable battery 1 does not need to be an onboard battery and may be a rechargeable battery for, for example, a ship, an aircraft, or a stationary battery.

The range of the viscosity of the negative electrode thickener contained in the negative electrode additive may be changed in accordance with the shear rate. In other words, a shear viscosity value may vary in accordance with the shear rate, and the viscosity of the negative electrode thickener may be changed in accordance with the shear rate.

While the present disclosure is described with reference to examples, the present disclosure is not limited to the example or the configuration of the example. The present disclosure includes various variations and modifications within an equivalent range. In addition, various combinations and forms and other combinations and forms, which include only one element or more, shall be within the scope or a range of ideas of the present disclosure.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a negative electrode plate of a rechargeable battery, the method comprising:
kneading a negative electrode active material and a negative electrode additive to form a negative electrode mixture paste;
applying the negative electrode mixture paste to a negative electrode current collector; and
drying the negative electrode mixture paste, wherein
a blackness of a material prepared by kneading the negative electrode active material and the negative electrode additive is set in a range of 4 to 16, and
a viscosity of a negative electrode thickener contained in the negative electrode additive is set in a range of 13000 mPa·s to 21000 mPa·s when a shear rate is 0.01 s⁻¹.

2. The method according to claim 1, wherein
the negative electrode additive includes at least the negative electrode thickener and a negative electrode solvent, and
the blackness of the material is a blackness of a primary kneaded material prepared by kneading the negative electrode active material, the negative electrode thickener, and the negative electrode solvent.

3. The method according to claim 2, wherein a solid content of the primary kneaded material is set to be in a range of 58% to 61%.

4. A negative electrode plate, comprising:
a negative electrode current collector forming a substrate of a negative electrode of a rechargeable battery; and
a negative electrode mixture layer formed by applying a negative electrode mixture paste to the negative electrode current collector and drying the negative electrode mixture paste, the negative electrode mixture paste being prepared by kneading a negative electrode active material and a negative electrode additive, wherein
a kneaded material of the negative electrode active material and the negative electrode additive has a blackness in a range of 4 to 16, and
the negative electrode additive contains a negative electrode thickener having a viscosity in a range of 13000 mPa·s to 21000 mPa·s when a shear rate is 0.01 s⁻¹.

5. A rechargeable battery, comprising:
a negative electrode plate of a negative electrode;
a positive electrode plate of a positive electrode; and
a separator arranged between the negative electrode plate and the positive electrode plate, wherein
the negative electrode plate includes a negative electrode current collector that forms a substrate of the negative electrode and a negative electrode mixture layer formed by applying a negative electrode mixture paste to the negative electrode current collector and drying the negative electrode mixture paste, the negative electrode mixture paste being prepared by kneading a negative electrode active material and a negative electrode additive,
a kneaded material of the negative electrode active material and the negative electrode additive has a blackness in a range of 4 to 16, and
the negative electrode additive contains a negative electrode thickener having a viscosity in a range of 13000 mPa·s to 21000 mPa·s when a shear rate is 0.01 s⁻¹.
